(19) United States
(12) Patent Application Publication
(10) Pub. No.: US 2013/0151722 A1
(43) Pub. Date: Jun. 13, 2013

(54) Method and Apparatus for Utilizing Streaming Content at an Electronic Device

(71) Applicants: Rachid Mohsen Alameh, Crystal Lake, IL (US); Timothy Dickinson, Crystal Lake, IL (US)

(72) Inventors: Rachid Mohsen Alameh, Crystal Lake, IL (US); Timothy Dickinson, Crystal Lake, IL (US)

(73) Assignee: Motorola Mobility, Inc., Libertyville, IL (US)

(21) Appl. No.: 13/324,458

(22) Filed: Dec. 13, 2011

(51) Int. Cl. G06F 15/16

(52) U.S. Cl. 709/231

(57) ABSTRACT

An apparatus and method of an electronic device for utilizing streaming content at the electronic device are disclosed herewith. The method includes providing the streaming content at an output component of the electronic device. The method further includes detecting a motion at a motion sensor of the electronic device above a predetermined threshold while the streaming content is provided at the output component. Furthermore, the method includes withholding a portion of the streaming content from the output component in response to detecting the motion at the motion sensor.

### FIELD OF THE DISCLOSURE

The present disclosure relates generally to an electronic device and more particularly to a method and apparatus for viewing and utilizing a streaming content at the electronic device.

### BACKGROUND

Wearable electronic devices are small in nature and typically contain small displays, such as a 1.6 inch display or less. Some wearable electronic devices can also accommodate certain type of displays, such as flexible displays, to supplement the main display. However, the display area is too small to fit enough content and still be readable when user is moving around, specifically in case of wrist-worn wearable devices.

Moreover, displays are considered power hungry devices which can be a detriment especially in small wearable devices with limited battery capacities. When the user is moving around, the user may not be able to view the content displayed on the display. However, the display still continues to display the content at the display. This may result in wastage of substantial amount of power.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a wireless communication system in accordance with some embodiments of the present invention.

FIG. 2 is a block diagram of an electronic device in accordance with some embodiments of the present invention.

FIG. 3 is a flowchart depicting a method for utilizing streaming content at an electronic device in accordance with some embodiments of the present invention.

FIG. 4 is a continuation of a flowchart of FIG. 3 depicting a method for utilizing streaming content at an electronic device in accordance with some embodiments of the present invention.

FIG. 5 is a flowchart depicting a method for utilizing streaming content at an electronic device in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail the particular method and system for utilizing a streaming content at an electronic device, in accordance with an embodiment of the present disclosure, it should be observed that the present disclosure resides primarily in combinations of method steps and apparatus components related to the method and system for utilizing streaming content at an electronic device. Accordingly, the apparatus components and method steps have been represented where appropriate by conventional symbols in the drawings, showing only those specific details that are pertinent to understanding the present disclosure, so as not to obscure the disclosure with details that will be readily apparent to those of ordinary skill in the art, having the benefit of the description herein.

An apparatus and method of an electronic device for utilizing streaming content at the electronic device are disclosed herewith. The method includes providing the streaming content at an output component of the electronic device. The method further includes detecting a motion at a motion sensor of the electronic device above a predetermined threshold while the streaming content is provided at the output component. Furthermore, the method includes withholding a portion of the streaming content from the output component in response to detecting the motion at the motion sensor.

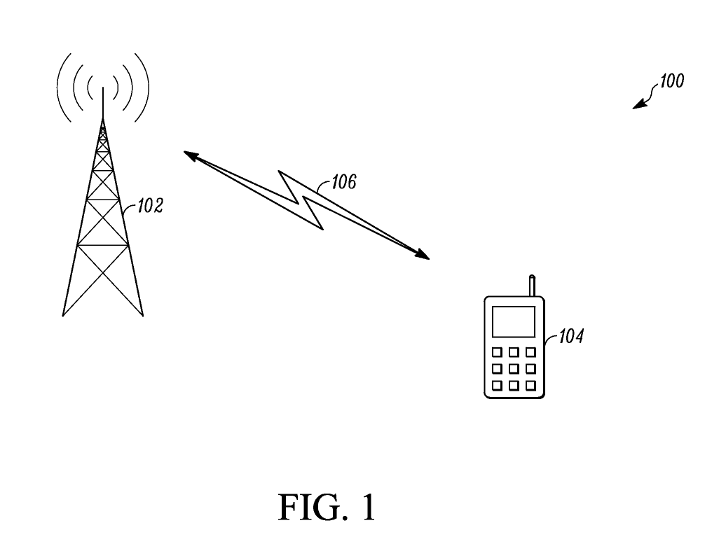

FIG. 1 illustrates a schematic of a wireless communication system 100 in accordance with some embodiments. The wireless communication system 100 includes one or more electronic devices 104 communicating with one or more base stations 102 via wireless links or wired links 106.

In accordance with the embodiment, the base station 102 in the wireless communication system 100 is configured to operate according to any of a number of different communication technologies including, but not limited to, 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Worldwide Interoperability for Microwave Access (WiMax), Long-Term Evolution (LTE) and other communication technologies.

Still referring to FIG. 1, an electronic device 104 is intended to be representative of any of a variety of wireless communication devices operated by persons (or users) or possibly by other entities (e.g., other computers) desiring or requiring communication capabilities. In some embodiments, for example, the electronic device 104 can be any of a call receiver, cellular telephone, a personal digital assistant (PDAs), a smart phone, another handheld or portable electronic device, a headset, a MP3 player, a battery-powered device, a wearable device, a radio, a navigation device, a laptop or notebook computer, a notebook, a pager, a PMP (personal media player), a DVR (digital video recorder), a gaming device, a camera, a notebook, an e-reader, an e-book, a tablet device, a navigation device with a video capable screen, a multimedia docking station, or another mobile. The electronic device 104 may be served by the base station 102. Additionally, the electronic device 104 may receive content from sources other than the base station 102, such as an access point or another electronic device.

Further, it is to be understood that FIG. 1 is provided merely for the purpose of illustrating the principles of the present invention. FIG. 1 is not intended to be a comprehensive schematic diagram of all of the components of such a communication system. Therefore, wireless communication system 100 may comprise various other configurations and still be within the scope of the present disclosure.

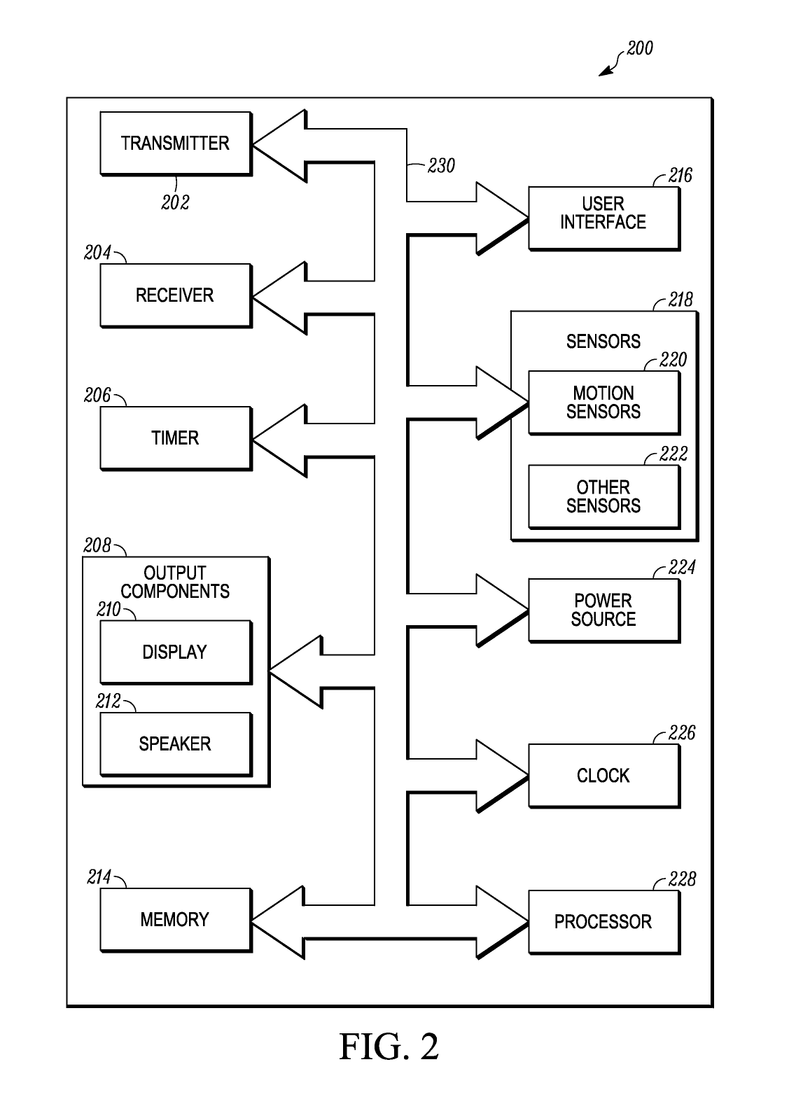

Referring to FIG. 2, there is provided a block diagram 200 illustrating example internal hardware components of the electronic device 104 of FIG. 1. The block diagram 200 of the electronic device 104 includes various components. The exemplary components may include a transmitter 202, a receiver 204, a timer 206, one or more output components 208 including a display 210 and a speaker 212, a memory 214, a user interface 216, one or more sensors 218 including motion sensors 220 and other sensors 222, a power source 224, a clock 226, and a processor 228, each capable of communicating with one or more components of the electronic device 104. For example, as shown in FIG. 2, all components may be coupled to a bidirectional control and data bus 230, but it is to be understood that the various components may be interconnected by any type of direct or indirect link capable of communicating control and/or data signals.

In accordance with an embodiment, the transmitter 202 can be implemented as a transmitting component of the electronic device 104. The transmitter 202 enables the electronic device 104 to transmit the RF signals through an antenna (not shown). Similarly, the receiver 204 can be implemented as a receiving component of the electronic device 104. The receiver 204 enables the electronic device 104 to receive the RF signals through an antenna (not shown). In accordance with the embodiment, the receiver 204 converts the RF signals received from the antenna to digital data for use by the processor 228.

In accordance with the embodiment, one or more output components 208 may generate visual indications of data generated during operation of the processor 228. The visual indications may include prompts for human operator input, calculated values, detected data, etc. Additionally, the one or more output components 208 may include a video output component such as a display 210 which includes cathode ray tube, liquid crystal display, plasma display, incandescent light, fluorescent light, front or rear projection display, and light emitting diode indicator. Other examples of the output components 208 include an audio output component such as a speaker 212, alarm and/or buzzer, and/or a mechanical output component such as vibrating or motion-based.

Further, the memory 214 may be used to store data and instructions for the operation of the processor 228. In the various embodiments, the memory 214 may be one or more separate components and/or may be partitioned in various ways for various purposes such as but not limited to, optimizing memory allocations, etc. Thus it is to be understood that the exemplary memory 214 illustrated in FIG. 2 are for illustrative purposes only, for the purpose of explaining and assisting one of ordinary skill in understanding the various embodiments described herein.

In accordance with the embodiment, the user interface 216 may be connected to the processor 228 for entering data and commands in the form of text, touch input, gestures, etc. The user interface 216 is, in one embodiment, a touch screen device but may alternatively be an infrared proximity detector or any input/output device combination capable of sensing gestures and/or touch including a touch-sensitive surface. In addition, the user interface 216 may include one or more additional components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and may include a pointing device such as a joystick and buttons used on laptop or notebook computers, a track ball, a touch pad, a rocker switch, a touch screen, a TTY input device for disable persons, a Braille key input, or a pad for handwriting pen, for example. The user interface 216 enables a user of the electronic device 104 to provide an input for the electronic device 104.

Still referring to FIG. 2, the electronic device 104 may include one or more sensors 218 which may include, for example, motion sensor 220 and other sensors 222. The motion sensor 220 may include an accelerometer, a Gyroscope (Gyro), a Global Positioning system (GPS), a compass, an imager, or a context sensor. Other sensors 222 may include proximity sensors (e.g., a light detecting sensor, an ultrasound transceiver or an infrared transceiver), touch sensors, altitude sensors, and one or more location circuits/components that can include, for example, a Global Positioning System (GPS) receiver, a triangulation receiver, an accelerometer, a tilt sensor, a gyroscope, or any other information collecting device that can identify a current location or user-device interface of the electronic device 104. While the sensors 218 for the purposes of FIG. 2 are considered to be distinct from the user interface 216, in other embodiments it is possible that one or more of the input devices or user interfaces can also be considered to constitute one or more of the sensors (and vice-versa).

Further, the power source 224, such as a battery, may be included in the internal components of the electronic device 104 for providing power to the other internal components and, for some embodiments, enable the electronic device 104 to be portable.

Further, the processor 228 operates in conjunction with the data and instructions stored in the memory 214 to control the operation of the electronic device 104. The processor 228 may be implemented as a microcontroller, a digital signal processor, hard-wired logic and analog circuitry, or any suitable combination of these. Also, the processor 228 may provide a variety of other functions, such as one or more timing functions. Of course, not all functions need to be performed by the processor 228, and the electronic device 104 may include components separate from the processor, such as a timer 206, clock 226 to provide those functions.

It is to be understood that FIG. 2 is for illustrative purposes only and is primarily for, although not solely for, explaining the information stored in memory for the various embodiments of an electronic device in accordance with the present disclosure, and is not intended to be a complete schematic diagram of the various components and connections there between required for an electronic device. Therefore, an electronic device 104 will comprise various other components not shown in FIG. 2, and/or have various other configurations internal and external, and still be within the scope of the present disclosure. Also, one or more of these components may be combined or integrated in a common component, or components features may be distributed among multiple components. Also, the components of the electronic device 104 may be connected differently, without departing from the scope of the invention.

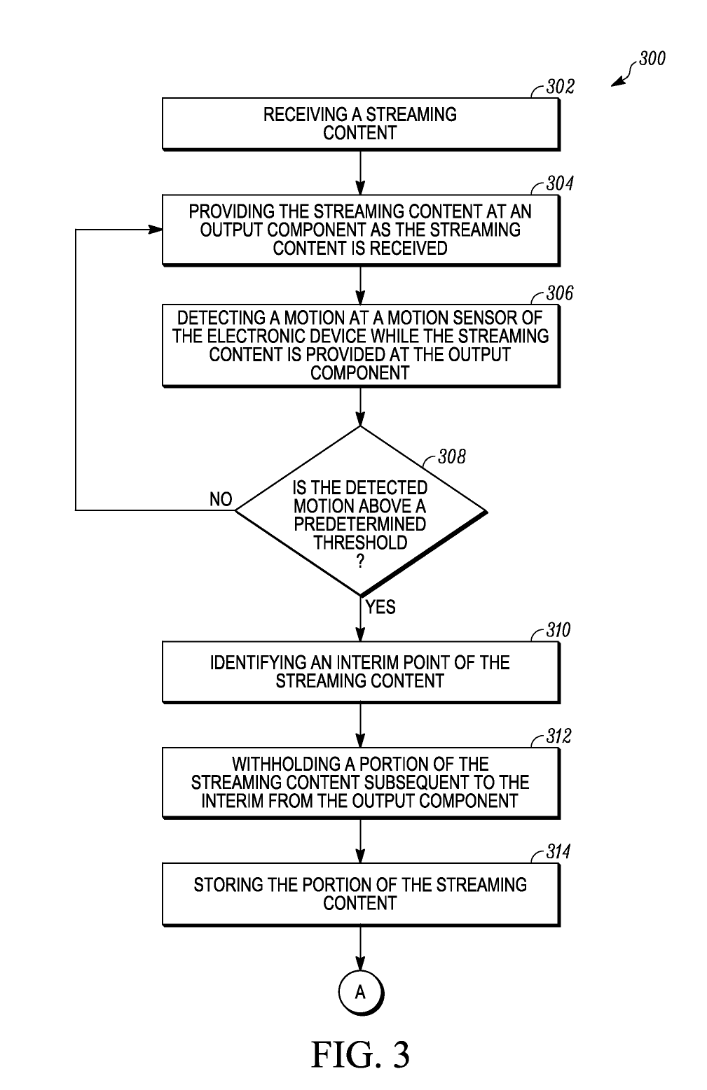

FIG. 3 is a flowchart of a method 300 for utilizing streaming content at an electronic device 104. Referring to FIG. 3, the method 300 starts at step 302. In accordance with an embodiment, the electronic device 104 receives 302 a streaming content at a receiver 204 of the electronic device 104. The streaming content may include visual, audio or multimedia feeds, such as at least one of live feeds, news briefs, text messages, multimedia messages, images, videos etc. Various other examples could be included herein. The method 300 then moves to a step of providing 304 the streaming content at an output component 208 as the streaming content is received at the receiver 204 of the electronic device 104. In accordance with an embodiment, the streaming content may be provided at a display 210 or some other output component 208 associated with the electronic device 104. For example, the streaming content may be displayed at the display 210. In other words, when the streaming content is received at the electronic device 104, the streaming content is displayed at the display 210 associated with the electronic device 104 so that the user may be able to view the streaming content at the display 210.

The method 300 then advances to a step of detecting 306 a motion at a motion sensor 220 of the electronic device 104 while the streaming content is provided at the output component 208. In accordance with some embodiments, the motion sensor 220 may detect that the user of the electronic device 104 is moving at a particular acceleration. Further, the motion sensor 220 may detect the motion relative to the user and may not be an absolute motion. In accordance with the embodiment, the motion sensor 220 may detect magnitude, phase, angle, rotation, speed, pattern, etc associated with the motion. Thus, the motion sensor 220 detects that the user associated with the electronic device 104 while viewing the streaming content at the electronic device 104 starts moving around at some acceleration or other motion.

The method 300 then moves to a step of determining 308, by a processor 228, if the detected motion or the acceleration associated with the user is above a predetermined threshold. The predetermined threshold may be a single value or a particular range of values of acceleration or other motion set by a user or a manufacturer of the electronic device 104. The predetermined threshold may also include factors such as magnitude, phase, angle, rotation, speed, pattern, etc. In accordance with the embodiment, the processor 228 determines if the motion causes the visibility of the streaming content to be affected from the perspective of the user. For example, when the electronic device 104 and the user associated with the electronic device 104 are moving synchronously e.g., in a moving train, the processor 228 may determine that the motion does not affect the visibility of the streaming content to the user. If the processor 228 determines 308 that the detected motion is above the predetermined threshold, the method 300 moves to the step of identifying 310 an interim point of the streaming content associated with detecting the motion at the electronic device 104. The interim point may indicate a point in the streaming content, provided at the output component 208, where the detected motion exceeds the predetermined threshold. In one example, when the user viewing the streaming content at the output component 208 of the electronic device 104 starts moving at an acceleration above the predetermined threshold, the electronic device 104 may identify an interim point of the streaming content associated with the motion of the user. The user may not be able to view, read, or see the streaming content when the user starts moving around.

Further, the processor 228 withholds 312 a portion of the streaming content subsequent to the interim point from the output component 208. For example, the processor 228 withholds the streaming content from being displayed at the display 210. In accordance with the embodiment, a backlight associated with the display 210 or the display 210 itself is disabled when the portion of the streaming content is withheld. This may be done to conserve battery and save power.

The method 300 then moves to a step of storing 314 the portion of the streaming content at a memory 214 of the electronic device 104. For example, the portion of the streaming content that is being withheld from being displayed at the display 210 is stored in the memory 214 of the electronic device 104. In other words, when the user viewing the streaming content at the display 210 starts moving at an acceleration above the predetermined threshold, the user may not able to view the streaming content properly. Consequently, the processor 228 may withhold the portion of streaming content subsequent to the detection of the user movement. Further, this portion of the streaming content may be stored at the memory 214.

In another embodiment, the portion of the streaming content may be provided to one or more output components 208 of the electronic device 104. For example, the portion of the streaming content may be played as an audio at a speaker 212 of the electronic device 104. In such a scenario, the user may be able to listen to the portion of the streaming content as an audio since the user may not be able to see the streaming content at the display 210 while the user is moving around.

In another example, when the user starts walking or running and is not able to see streaming content, the portion of the streaming content may be delivered to another electronic device which may be viewed by the user at a later time. In still another example, the entire streaming content both antecedent and subsequent to the interim point may be viewed by the user at a later time on the same or a different electronic device.

However, if at the step 308, the processor 228 determines 308 that the detected motion or the acceleration of the user is not above the predetermined threshold, the method 300 then moves back to the step 304.

Therefore, in accordance with the embodiments of the present invention, a user viewing the streaming content at the display 210 of the electronic device 104 may start moving around. As the user starts to move around, it may become much harder to view streaming content due to the smaller display size. The electronic device 104 may determine that the motion of the user or the acceleration associated with the user is above the predetermined threshold and thus user may have limited viewing ability. Further, the electronic device 104 may determine an interim point of the streaming content identifying the point in the streaming content when the detected motion is above the predetermined threshold. Consequently, the electronic device 104 may withhold a portion of the streaming content subsequent to the interim point from being displayed at the display 210 of the electronic device 104. This portion of the streaming content may be stored in the memory 214 of the electronic device 104 and may be viewed at a later time when the user stops moving.

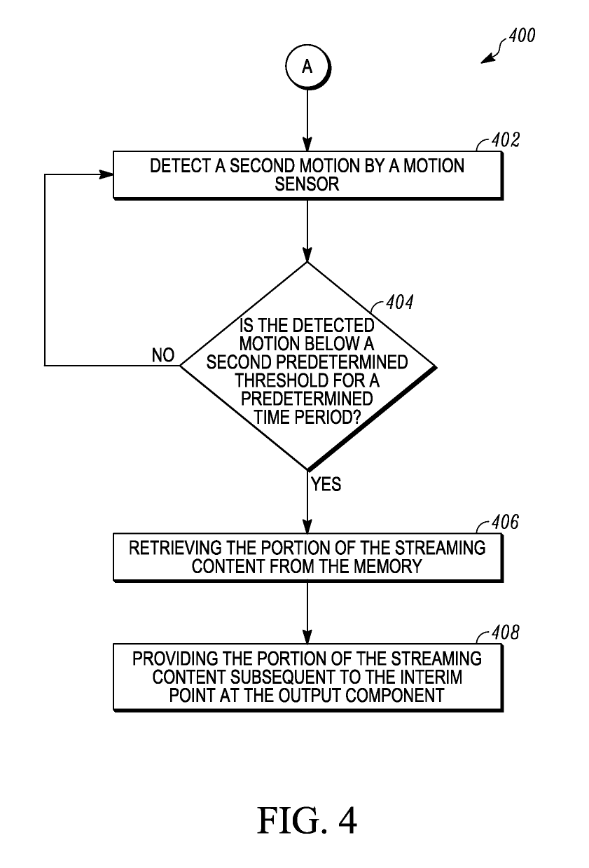

FIG. 4 is a flowchart showing the steps subsequent to the steps shown in the flowchart of FIG. 3. The flowchart 400 illustrates the steps in accordance with some embodiments of the present invention when the user stops moving or starts moving at a very low speed. The method 400 begins at a step of detecting 402 a second motion by a motion sensor 220 of the electronic device 104. The method 400 then moves to a step of determining 404, by the processor 228, if the detected motion is below a second predetermined threshold for a predetermined time period. The second predetermined threshold may identify acceleration or some other motion associated with the user indicating that the user is not moving or moving at a very low acceleration and this may be set by a user or manufacturer of the electronic device 104. The predetermined time period identifies the minimum time period for which detected motion is below the second predetermined threshold. Both the second predetermined threshold and the predetermined threshold may be stored in the memory 214 of the electronic device 104.

If the processor 228 determines 404 that the detected motion is below a second predetermined threshold for a predetermined time period, the method 400 moves to a step of retrieving 406 the portion of the streaming content from the memory 214 of the electronic device 104. As described in the description corresponding to the FIG. 3, the portion of the streaming content may be stored in the memory 214 of the electronic device 104. The processor 228 retrieves the stored streaming content from the memory 214. The method 400 then moves to a step of providing 408 the portion of the streaming content at the output component 208 of the electronic device 104. In one example, the portion of the streaming content may be provided at the display 210 of the electronic device 104.

However, if the processor 228 determines 404 that the detected motion is not below a second predetermined threshold for a predetermined time period, the method 400 loops back to the step 402.

Thus, in accordance with the embodiments of the present invention, when the acceleration of the user is below a second predetermined threshold or when it is determined that the user has stopped moving or is moving at a very low acceleration, the portion of the streaming content stored in the memory 214 may be retrieved from the memory 214 and displayed at the display 210. In one example, the entire streaming content both antecedent and subsequent to the interim point may be displayed at the display 210 when the user stops moving. For example, user downloads an article from the web, starts the download and display of content on a small screen. The user then starts moving. User only read a portion of the content that fits the screen before the user started moving. The download action is repeated as soon as motion ceases allowing user to read entire document and associated links.

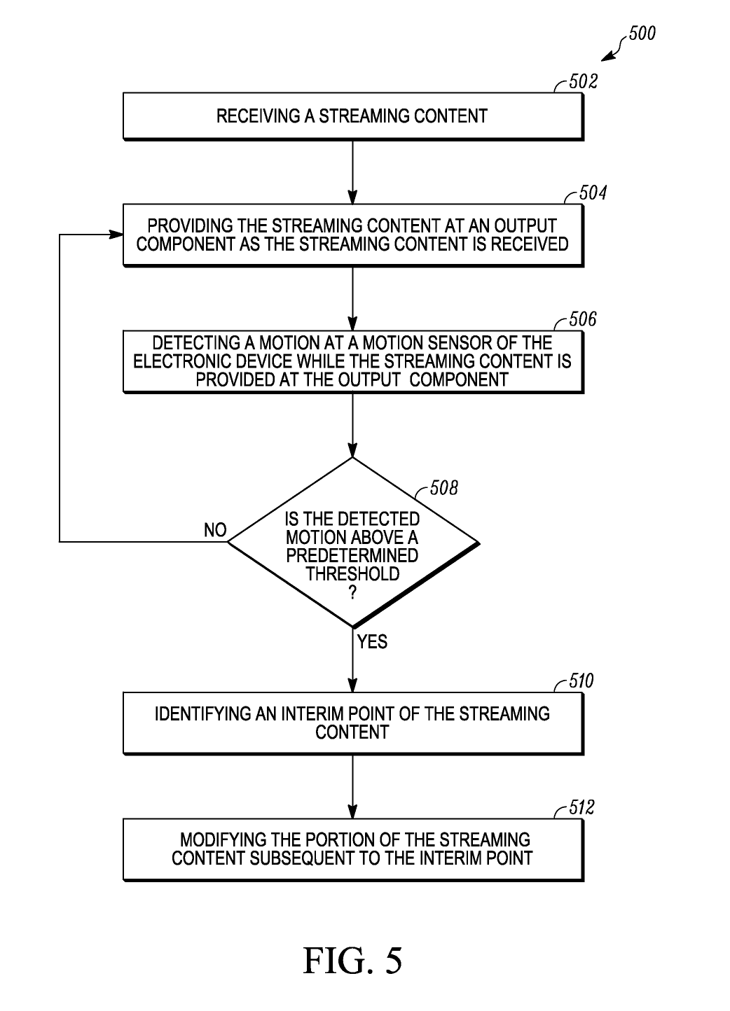

FIG. 5 is a flowchart for a method 500 for utilizing streaming content at an electronic device. Referring to FIG. 5, the method 500 starts at step 502. FIG. 5 is a flowchart for a method 500 for utilizing streaming content at an electronic device 104. Referring to FIG. 5, the method 500 starts at step 502. In accordance with an embodiment, the electronic device 104 receives 502 a streaming content at a receiver 204 of the electronic device 104. The streaming content may include visual, audio or multimedia feeds, such as at least one of live feeds, news briefs, text messages, multimedia messages, images, videos etc. Various other examples could be included herein. The method 500 then moves to a step of providing 504 the streaming content at an output component 208 as the streaming content is received at the receiver 204 of the electronic device 104. In accordance with an embodiment, the streaming content may be provided at a display 210 or some other output component 208 associated with the electronic device 104. For example, the streaming content is displayed at the display 210 so that the user may be able to view the streaming content at the display 210.

The method 500 then advances to a step of detecting 506 a motion at a motion sensor 220 of the electronic device 104 while the streaming content is provided at the output component 208. In accordance with the embodiment, the motion sensor 220 may detect that the user of the electronic device 104 is moving at a particular acceleration. Further, the motion sensor 220 may detect the motion relative to the user and may not be an absolute motion. For example, if a user is driving, an electronic device is in motion but the relative position of the electronic device with respect to the user relative position is not changing so content visibility is not impacted. In accordance with the embodiment, the motion sensor 220 may detect magnitude, phase, angle, rotation, speed, pattern, etc associated with the motion. Thus, the motion sensor 220 detects that the user associated with the electronic device 104 while viewing the streaming content at the electronic device 104 starts moving around at a particular acceleration. The method 500 then moves to a step of determining 508, by a processor 228, if the detected motion is above a predetermined threshold. The predetermined threshold may be a single value or a particular range of values of acceleration or some other motion set by a user or a manufacturer of the electronic device 104. The predetermined threshold may also include factors such as magnitude, phase, angle, rotation, speed, pattern, etc. In accordance with the embodiment, the processor 228 determines if the motion causes the streaming content to be invisible to the user. For example, when the electronic device 102 and the user associated with the electronic device are moving synchronously e.g., in a moving train, the processor 228 may determine that the motion does not affect the visibility of the streaming content to the user.

If the processor 228 determines 508 that the detected motion is above the predetermined threshold, the method 500 moves to the step of identifying 510 an interim point of the streaming content associated with detecting the motion of the electronic device 104. The interim point may indicate a point in the streaming content, provided at the output component 208, where the detected motion exceeds the predetermined threshold. In one example, when the user viewing the streaming content at the output component 208 of the electronic device 104 starts moving at an acceleration above the predetermined threshold, the electronic device 104 may identify an interim point of the streaming content associated with the motion of the user. The user may not be able to view, read, or see the streaming content when the user starts moving around, i.e., the user starts running or walking.

The processor 228 then modifies 512 the portion of the streaming content provided to the output component 208 subsequent to the interim point. In one embodiment, modifying the portion of the streaming content provided to the output component 208 may include modifying at least one of a speed of scroll, font type, font size, color, design, or style of the portion of the streaming content provided to the output component 208 in response to detecting the motion at the motion sensor 220.

In another embodiment, modifying the portion of the streaming content provided to the output component 208 may include modifying the portion of the streaming content provided to the output component 208 based on a context of the electronic device 104. Herein, the context of the electronic device 104 may include at least one of a time, weather, vehicle transport, altitude, or atmosphere associated with the electronic device 104.

In another embodiment, modifying the portion of the streaming content provided to the output component 208 may include modifying the portion of the streaming content provided to the output component 208 based on a context stored in a memory 214 of the electronic device 104. Herein, the context stored in the memory 214 of the electronic device 104 includes at least one of a medical profile, wellness profile, or a physical profile associated with at least one user of the electronic device 104.

In another embodiment, modifying the portion of the streaming content provided to the output component 208 may include modifying the portion of the streaming content provided to the output component 208 based on a motion of the electronic device 104. Herein, the motion of the electronic device 104 may be relative to at least one of a hand movement, a leg movement, an eyes movement, or a head movement of a user associated with the electronic device 104.

On the other hand, if the processor 228 determines 508 that the detected motion or the acceleration of the user is not above the predetermined threshold, the method 500 then moves back to the step 504.

Thus, in accordance with the above embodiments, a power-friendly scheme is proposed to optimize user visual interface with small displays when user is moving around and at the same time avoid un-necessarily wasting display power when data is determined not to be readable due to user motion exceeding certain thresholds.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, and/or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of an electronic device for utilizing streaming content at the electronic device, the method comprising:
providing the streaming content at an output component of the electronic device;
detecting a motion at a motion sensor of the electronic device above a predetermined threshold while the streaming content is provided at the output component; and
withholding a portion of the streaming content from the output component in response to detecting the motion at the motion sensor.

2. The method of claim 1, further comprising:
identifying an interim point of the streaming content associated with detecting the motion at the motion sensor; and
withholding the portion of the streaming content from the output component includes withholding the portion of the streaming content subsequent to the interim point from the output component.

3. The method of claim 2, further comprising:
providing at least the portion of the streaming content to a second component of the electronic device.

4. The method of claim 3, wherein the second component is a memory configured to store the at least the portion of the streaming content.

5. The method of claim 3, wherein the second component is a second output component configured to provide the at least the portion of the streaming content.

6. The method of claim 1, further comprising receiving the streaming content at a receiver of the electronic device,
wherein providing the streaming content at the output component of the electronic device includes providing the streaming content at the output component as the streaming content is received by the receiver.

7. The method of claim 1, further comprising:
detecting a second motion at the motion sensor;
determining that the second motion is below a second predetermined threshold for a predetermined time period while the portion of the streaming content is withheld from the output component; and
providing at least the portion of the streaming content at the output component.

8. A method of an electronic device for utilizing streaming content at the electronic device, the method comprising:
providing the streaming content at an output component of the electronic device;
detecting a motion at a motion sensor of the electronic device above a predetermined threshold while the streaming content is provided at the output component; and
modifying a portion of the streaming content provided to the output component in response to detecting the motion at the motion sensor.

9. The method of claim 8, further comprising:
identifying an interim point of the streaming content associated with detecting the motion at the motion sensor; and
modifying the portion of the streaming content provided to the output component includes modifying the portion of the streaming content subsequent to the interim point.

10. The method of claim 8, wherein:
modifying the portion of the streaming content provided to the output component includes modifying at least one of a speed of scroll, font, color, design, or style of the portion of the streaming content provided to the output component in response to detecting the motion at the motion sensor.

11. The method of claim 8, wherein:
modifying the portion of the streaming content provided to the output component includes modifying the portion of the streaming content provided to the output component based on a context of the electronic device.

12. The method of claim 11, wherein the context of the electronic device includes at least one of a time, weather, vehicle transport, altitude, or atmosphere associated with the electronic device.

13. The method of claim 8, wherein:
modifying the portion of the streaming content provided to the output component includes modifying the portion of the streaming content provided to the output component based on a motion of the electronic device.

14. The method of claim 13, wherein:
modifying the portion of the streaming content provided to the output component based on the motion of the electronic device includes modifying the portion of the streaming content provided to the output component based on the motion of the electronic device relative to at least one of a hand movement, a leg movement, an eyes movement, or a head movement of a user associated with the electronic device.

15. The method of claim 8, wherein:
modifying the portion of the streaming content provided to the output component includes modifying the portion of the streaming content provided to the output component based on a context stored in a memory of the electronic device,
wherein the context stored in the memory of the electronic device includes at least one of a medical profile, wellness profile, or a physical profile associated with at least one user of the electronic device.

16. The method of claim 8, wherein the motion sensor is at least one of an accelerometer, a Gyrometer (Gyro), a Global Positioning system (GPS), a compass, an imager, or a context sensor.

17. An electronic device for utilizing streaming content, the electronic device comprising:
an output component configured to provide the streaming content;
a motion sensor configured to detect a motion above a predetermined threshold; and
a processor configured to withhold at least a portion of the streaming content from the output component based on detecting the motion at the motion sensor.

18. The electronic device of claim 17, wherein the output component is a display.

19. The electronic device of claim 17, wherein the processor is further configured to identify an interim point of the streaming content associated with detecting the motion at the motion sensor; and
the processor configured to withhold the portion of the streaming content from the output component includes withholding the portion of the streaming content subsequent to the interim point from the output component.

20. The electronic device of claim 18, wherein the processor is further configured to provide the portion of the streaming content to a second output component, wherein the second output component is at least one of a memory or a speaker.

21. An electronic device for utilizing streaming content, the electronic device comprising:
an output component configured to provide the streaming content;
a motion sensor configured to detect a motion above a predetermined threshold; and
a processor configured to modify a portion of the streaming content provided to the output component based on detecting the motion at the motion sensor.
